(19) United States
(12) Patent Application Publication
(10) Pub. No.: US 2014/0120254 A1
(43) Pub. Date: May 1, 2014

(54) FEED CAP

(71) Applicant: GRACO MINNESOTA INC., Minneapolis, MN (US)

(72) Inventors: Daniel P. Ross, Maplewood, MN (US); Joseph E. Tix, Hastings, MN (US)

(73) Assignee: GRACO MINNESOTA INC., Minneapolis, MN (US)

(21) Appl. No.: 13/705,589

(22) Filed: Dec. 5, 2012

Related U.S. Application Data
(60) Provisional application No. 61/718,207, filed on Oct. 25, 2012.

(51) Int. Cl. B05C 9/14; B05D 5/10

(52) U.S. Cl. CPC B05C 9/14; B05D 5/10
USPC 427/207.1; 222/146.2; 222/1

(57) ABSTRACT

A hot melt dispensing system includes a melter for heating adhesive pellets into liquefied adhesive pellets and a feed cap connected to the melter. The melter includes a collection surface defining a melter collection area. The feed cap has a feed inlet for receiving a supply of adhesive pellets and air. The feed cap also has a ventilation window system positioned with respect to the feed inlet so as to induce air flow out the ventilation window system and to induce the distribution of the adhesive pellets throughout the melter collection area.

### BACKGROUND

The present disclosure relates generally to systems for dispensing hot melt adhesive. More particularly, the present disclosure relates to feed systems.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

### SUMMARY

According to the present invention, a hot melt dispensing system includes a melter for heating adhesive pellets into liquefied adhesive pellets and a feed cap connected to the melter. The feed cap includes a cap top and a cap side, a feed inlet on the cap top for receiving a supply of adhesive pellets and air, and a first ventilation window on the cap side.

Another embodiment is a hot melt dispensing system including a melter for heating adhesive pellets into liquefied adhesive pellets and a feed cap connected to the melter. The melter includes a collection surface defining a melter collection area. The feed cap has a feed inlet for receiving a supply of adhesive pellets and air. The feed cap also has a ventilation window system positioned with respect to the feed inlet so as to induce air flow out the ventilation window system and to induce the distribution of the adhesive pellets throughout the melter collection area.

Another embodiment is a method of operating a hot melt dispensing system. The method includes transporting adhesive pellets from a container through a feed system, flowing air and the adhesive pellets from the feed system through a feed inlet of a feed cap attached to a melter, and flowing air from the feed inlet through the feed cap and out a ventilation window system so as to distribute the adhesive pellets substantially evenly in the melter.

### BRIEF DESCRIPTION OF THE DRAWINGS

FIG. 1 is a schematic view of a system for dispensing hot melt adhesive.

FIG. 2 is a side schematic view of a melt system used in the system of FIG. 1.

FIG. 3 is a side sectional schematic view of the melt system of FIG. 2.

FIG. 4A is a perspective view of an alternative embodiment of a feed cap and a melter for use in the melt system of FIGS. 2 and 3.

FIG. 4B is a perspective view of the melter of FIG. 4A.

### DETAILED DESCRIPTION

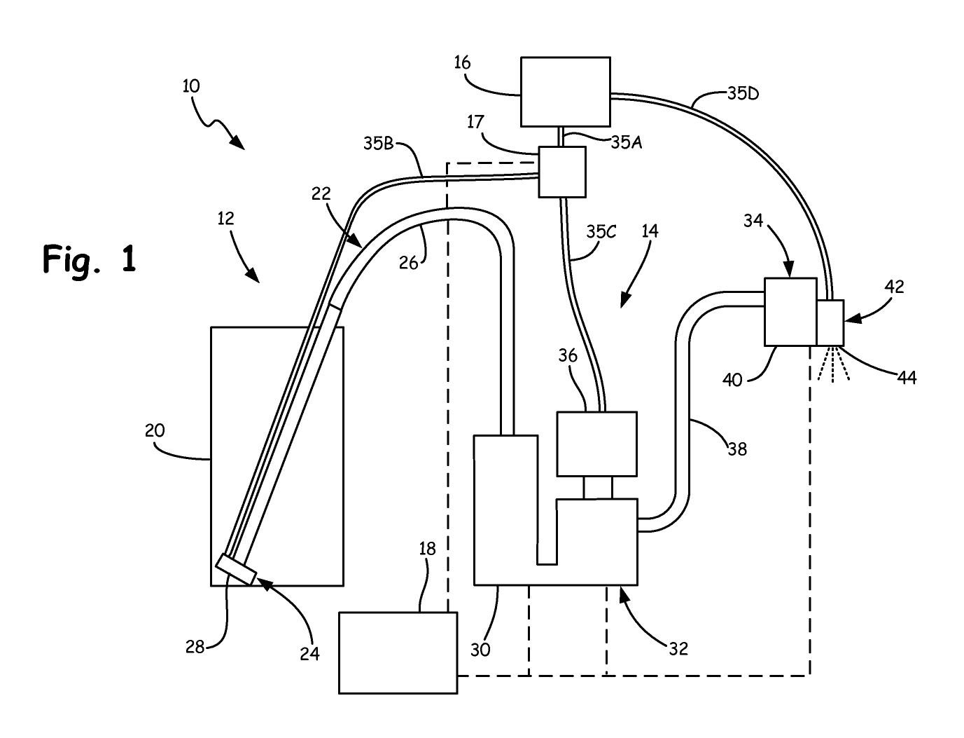

FIG. 1 is a schematic view of system 10, which is a system for dispensing hot melt adhesive. System 10 includes cold section 12, hot section 14, air source 16, air control valve 17, and controller 18. In the embodiment shown in FIG. 1, cold section 12 includes container 20 and feed assembly 22, which includes vacuum assembly 24, feed hose 26, and inlet 28. In the embodiment shown in FIG. 1, hot section 14 includes melt system 30, pump 32, and dispenser 34. Air source 16 is a source of compressed air supplied to components of system 10 in both cold section 12 and hot section 14. Air control valve 17 is connected to air source 16 via air hose 35A, and selectively controls air flow from air source 16 through air hose 35B to vacuum assembly 24 and through air hose 35C to motor 36 of pump 32. Air hose 35D connects air source 16 to dispenser 34, bypassing air control valve 17. Controller 18 is connected in communication with various components of system 10, such as air control valve 17, melt system 30, pump 32, and/or dispenser 34, for controlling operation of system 10.

Components of cold section 12 can be operated at room temperature, without being heated. Container 20 can be a hopper for containing a quantity of solid adhesive pellets for use by system 10. Suitable adhesives can include, for example, a thermoplastic polymer glue such as ethylene vinyl acetate (EVA) or metallocene. Feed assembly 22 connects container 20 to hot section 14 for delivering the solid adhesive pellets from container 20 to hot section 14. Feed assembly 22 includes vacuum assembly 24 and feed hose 26. Vacuum assembly 24 is positioned in container 20. Compressed air from air source 16 and air control valve 17 is delivered to vacuum assembly 24 to create a vacuum, inducing flow of solid adhesive pellets into inlet 28 of vacuum assembly 24 and then through feed hose 26 to hot section 14. Feed hose 26 is a tube or other passage sized with a diameter substantially larger than that of the solid adhesive pellets to allow the solid adhesive pellets to flow freely through feed hose 26. Feed hose 26 connects vacuum assembly 24 to hot section 14.

Solid adhesive pellets are delivered from feed hose 26 to melt system 30. Melt system 30 can include a container (not shown) and resistive heating elements (not shown) for melting the solid adhesive pellets to form a hot melt adhesive in liquid form. Melt system 30 can be sized to have a relatively small adhesive volume, for example about 0.5 liters, and configured to melt solid adhesive pellets in a relatively short period of time. Pump 32 is driven by motor 36 to pump hot melt adhesive from melt system 30, through supply hose 38, to dispenser 34. Motor 36 can be an air motor driven by pulses of compressed air from air source 16 and air control valve 17. Pump 32 can be a linear displacement pump driven by motor 36. In the illustrated embodiment, dispenser 34 includes manifold 40 and module 42. Hot melt adhesive from pump 32 is received in manifold 40 and dispensed via module 42. Dispenser 34 can selectively discharge hot melt adhesive whereby the hot melt adhesive is sprayed out outlet 44 of module 42 onto an object, such as a package, a case, or another object benefiting from hot melt adhesive dispensed by system 10. Module 42 can be one of multiple modules that are part of dispenser 34. In an alternative embodiment, dispenser 34 can have a different configuration, such as a handheld gun-type dispenser. Some or all of the components in hot section 14, including melt system 30, pump 32, supply hose 38, and dispenser 34, can be heated to keep the hot melt adhesive in a liquid state throughout hot section 14 during the dispensing process.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from melt system 30 and instead attached to dispenser 34. Supply hose 38 can then connect melt system 30 to pump 32.

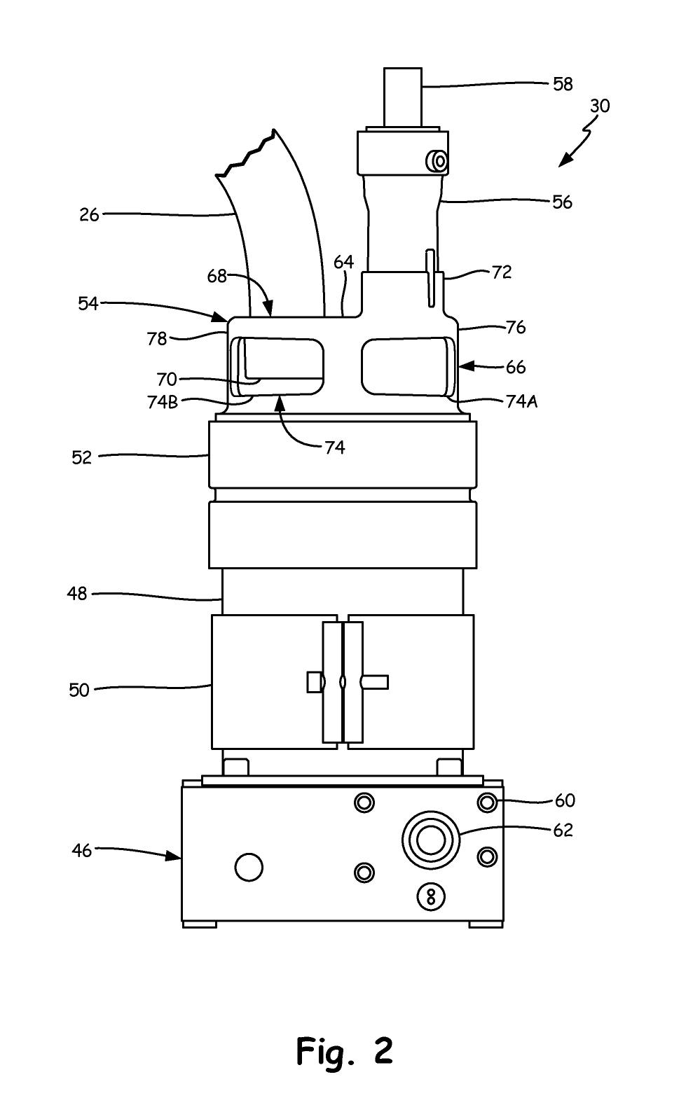

FIG. 2 is a side schematic view of melt system 30. In the illustrated embodiment, melt system 30 includes melter base 46, melter 48, band heater 50, thermal break 52, feed cap 54, sensor tower 56, and level sensor 58. Melter 48 is positioned on and supported by melter base 46. Melter base 46 includes bolt holes 60 for connecting melter base 46 to pump 32 (shown in FIG. 1). Melter base 46 also includes outlet 62 to allow fluid flow of hot melt adhesive from melter 48 to pump 32. Band heater 50 is attached to melter 48 for heating melter 48. Band heater 50 is an electrically powered resistive heating element wrapped circumferentially around and in contact with melter 48 for conducting heat from band heater 50 to melter 48. Melter 48 is a container for melting adhesive pellets into a liquid state, and for holding both the adhesive pellets in a solid state and the hot melt adhesive in the liquid state. In the illustrated embodiment, melter 48 is substantially cylindrical. In alternative embodiments, melter 48 can have a different shape, such as oval, square, rectangular, or another shape suitable for the application. Thermal break 52 is a connector that connects feed cap 54 to melter 48. Thermal break 52 can reduce heat conduction from relatively hot melter 48 to relatively cool feed cap 54. Thermal break 52 can be made of silicone or another material having a relatively low thermal conductivity. In alternative embodiments, thermal break 52 can be omitted and feed cap 54 can be connected to melter 48 either directly or via another suitable mechanism.

Feed cap 54 is a cover for melter 48 and melt system 30, connected to a top of melter 48. In one embodiment, feed cap 54 can be made of a polymer material. In alternative embodiments, feed cap 54 can be made of another material, such as a metal. Feed cap 54 includes cap top 64 and cap side 66. In the illustrated embodiment, cap side 66 is substantially cylindrical and cap top 64 has a substantially circular shape when viewed from above. Feed cap 54 can have a shape that is similar to that of melter 48, or can have a shape that differs from that of melter 48.

Feed inlet 68 is positioned on cap top 64 and includes inward projection 70, extending downward from cap top 64. Feed inlet 68 is a hole through cap top 64 and is connected to feed hose 26 for receiving a supply of adhesive pellets and air supplied by feed assembly 22 (shown in FIG. 1). Feed assembly 22 is a feed system for feeding the supply of adhesive pellets from container 20 (shown in FIG. 1). Feed hose 26 extends into inward projection 70 of feed inlet 68.

Sensor connection 72 is positioned on cap top 64 and connects to sensor tower 56 and level sensor 58. Sensor tower 56 connects level sensor 58 to feed cap 54 such that level sensor 58 is aimed toward a top of melter 48. In the illustrated embodiment, level sensor 58 is an ultrasonic sensor for sensing a level of adhesive pellets in melter 48. In alternative embodiments, level sensor 58 can be another type of sensor that is suitable for the application, such as an optical sensor.

Cap side 66 of feed cap 54 has ventilation window system 74. In the illustrated embodiment, ventilation window system 74 includes windows 74A and 74B extending through cap side 66 of feed cap 54. Windows 74A and 74B are holes in feed cap 54 allowing air flow through windows 74A and 74B. A screen or other filter (not shown) can cover windows 74A and 74B to allow flow of air out of feed cap 54 through windows 74A and 74B while preventing escape of solid adhesive pellets. Cap side 66 has side portion 76 positioned substantially opposite side portion 78. Window 74A is on side portion 76 and window 74B is on side portion 78.

Feed inlet 68 and feed hose 26 are positioned nearer side portion 78 than side portion 76. Thus, side portion 76 and window 74A are distal from feed inlet 68 and feed hose 26. Sensor connection 72, level sensor 58, and sensor tower 56 are positioned nearer side portion 76 than side portion 78. Thus, side portion 78 and window 74B are distal from sensor connection 72, level sensor 58, and sensor tower 56. Windows 74A and 74B are used to guide air from feed hose 26 out of cap 54, thereby influencing flow of adhesive pellets as they flow into melter 48.

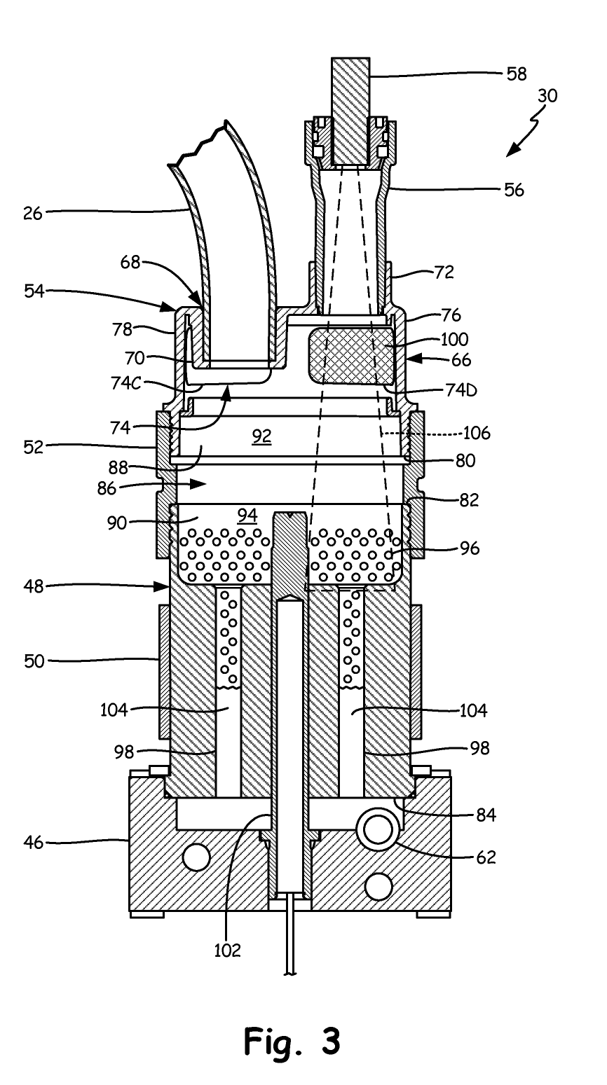

FIG. 3 is a side sectional schematic view of melt system 30. As shown in FIG. 3, ventilation window system 74 includes windows 74C and 74D in addition to windows 74A and 74B (shown in FIG. 2). In the illustrated embodiment shown in FIGS. 2 and 3, windows 74A, 74B, 74C, and 74D are positioned substantially symmetrically about feed cap 54. Window 74C is on side portion 78 and window 74D is on side portion 76. Thus, window 74D is distal from feed inlet 68 and feed hose 26, and window 74C is distal from sensor connection 72, level sensor 58, and sensor tower 56.

Feed cap 54 includes cap bottom 80, positioned opposite of cap top 54. Melter 48 includes melter top 82 and melter bottom 84 positioned opposite of melter top 82. Feed cap 54 connects to melter top 82 via thermal break 52 so as to define pellet collection area 86 between feed cap 54 and melter 48. Thermal break 52 is a heat insulator allowing feed cap 54 to be cooler than melter 48. Pellet collection area 86 includes feed cap collection area 88 and melter collection area 90. Feed cap collection area 88 is substantially defined by interior surface 92 of feed cap 54 and can be relatively cool as compared to melter collection area 90. Melter collection area 90 is substantially defined by collection surface 94 of melter 48. Collection surface 94 is substantially bowl-shaped extending downward from melter top 82. Feed cap collection area 88 is positioned above melter collection area 90. Pellet collection area 86 (including feed cap collection area 88 and melter collection area 90) receive and collect adhesive pellets 96 passing through feed inlet 68. Adhesive pellets 96 collected in pellet collection area 86 fall down to settle in melter collection area 90 below pelter top 82. In the illustrated embodiment, the part of pellet collection area 86 defined as feed cap collection area 88 does not contain adhesive pellets 96 except when passing through to melter collection area 90. Melter 48 has a plurality of passages 98 extending from collection surface 94 near melter top 82 to melter bottom 84 for receiving and melting the adhesive pellets 96.

During operation of melt system 30 as part of system 10 (shown in FIG. 1), a supply of adhesive pellets entrained in air is transported by feed assembly 22 (shown in FIG. 1) from container 20 (shown in FIG. 1) through feed hose 26, and through feed inlet 68 of feed cap 54. Air entering feed cap 54 through feed inlet 68 is vented through ventilation window system 74. As air flows from feed inlet 68 laterally outward toward windows 74A, 74B, 74C, and 74D, entrained adhesive pellets 96 are also induced to flow laterally outward, away from feed inlet 68 and toward windows 74A, 74B, 74C, and 74D. The air can flow out windows 74A, 74B, 74C, and 74D while adhesive pellets 96 are kept in pellet collection area 86 by screen 100. Though screen 100 is shown only with respect to window 74D, screen 100, or other individual screens, can be used with windows 74A, 74B, and 74C as well. Adhesive pellets 96 are directed downward toward melter top 82 by force of gravity, to collect in melter collection area 90. Thus, ventilation window system 74 is positioned with respect to feed inlet 68 so as to induce air flow out ventilation window system 74 and to distribute and induce adhesive pellets to settle substantially evenly in melter 48. Because adhesive pellets 96 are forced in the direction of windows 74A-74D, adhesive pellets 96 are distributed throughout melter collection area 90 and settle over a wider surface area at collection surface 94.

Adhesive pellets 96 are then melted by melter 48. Adhesive pellets 96 flow from melter collection area 90 and through passages 98. Melter 48 is heated from its exterior by band heater 50 and from its interior by heater cartridge 102 to melt adhesive pellets 96 into liquid adhesive 104 as adhesive pellets 96 flow through passages 98. Liquid adhesive 104 is a liquefied version of adhesive pellets 96 that is suitable for flowing through outlet 62, to pump 32 (shown in FIG. 1), and to dispenser 34 (shown in FIG. 1) for adhering packages, cases, or other objects.

FIG. 3 illustrates sensor beam 106 extending from level sensor 58 toward adhesive pellets 96 in melter collection area 90. In embodiments where level sensor 58 is an ultrasonic sensor, sensor beam 106 is an acoustic beam. In embodiments where level sensor 58 is an optical sensor, sensor beam 106 is a light beam. Level sensor 58 uses data from sensor beam 106 to determine a level of pellets in melter collection area 90. Level sensor 58 can send level data to controller 18, which can then determine whether melt system 30 has a sufficient quantity of adhesive pellets 96 or whether additional adhesive pellets 96 should be added.

By distributing adhesive pellets 96 substantially evenly in melter 48, level sensor 58 can get a relatively accurate indication of the level of adhesive pellets in melter 48. If, however, adhesive pellets 96 were not distributed substantially evenly in melter 48, level sensor 58 could undesirably indicate an inaccurately high or low level. This could cause melt system 30 to become over-filled or under-filled, either of which can cause improper operation of melt system 30.

For example, if ventilation window system 74 included only window 74C, air and adhesive pellets 96 entering through feed inlet 68 would be induced to flow toward window 74C on side portion 78, but not toward side portion 76. Since window 74C and feed inlet 68 are both near the same side portion 78, adhesive pellets 96 can have a tendency to settle unevenly in melter 48, under feed inlet 68 but not under level sensor 58. Thus, level senor 58 could indicate an inaccurately low quantity of adhesive pellets 96. Moreover, because melter 48 has a plurality of passages 98 spaced around melter 48, an uneven distribution of adhesive pellets 96 can cause adhesive pellets to flow into some but not all of the plurality of passages 98. This can reduce the melt rate of melt system 30 below a rate suitable for an application.

Thus, instead of using just window 74C, window 74D can be included on side portion 76 distal from feed inlet 68, to induce flow of adhesive pellets 96 toward side portion 76 to settle more evenly in melter 48. In the illustrated embodiment, ventilation window system 74 includes four windows 74A, 74B, 74C, 74D sized and orientated to induce adhesive pellets 96 to settle substantially evenly in melter 48. In alternative embodiments, ventilation window system 74 can be modified to have a different quantity, size, or orientation of windows so long as ventilation window system 74 is suitable for inducing adhesive pellets 96 to settle substantially evenly in melter 48.

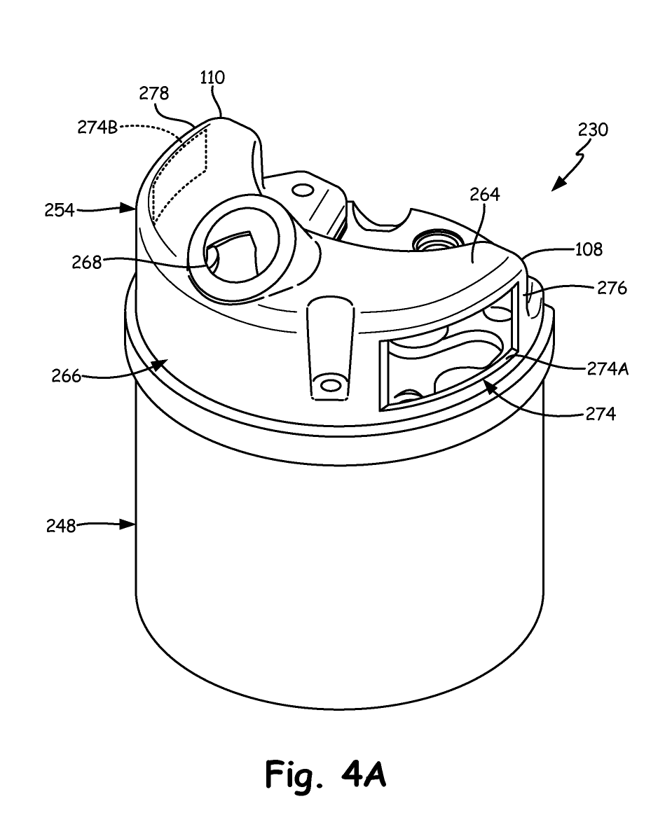

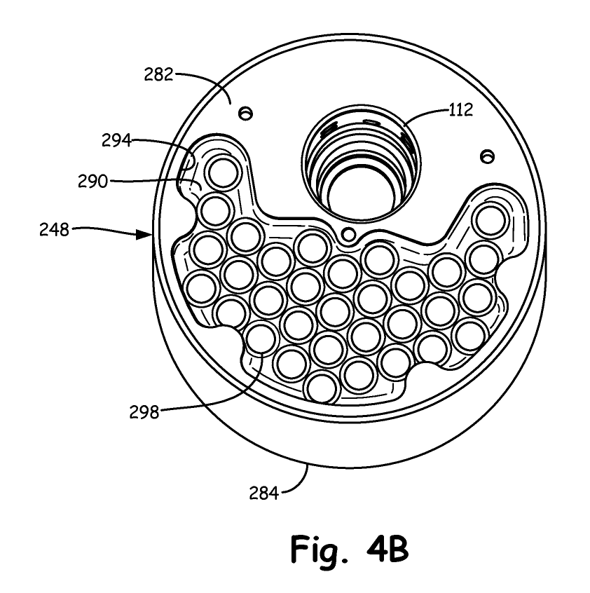

FIG. 4A is a perspective view of an alternative embodiment of feed cap 254 and melter 248 for use in melt system 230. Feed cap 254 is similar to feed cap 54 (shown in FIGS. 2 and 3) except feed cap 254 has a crescent shape with end 108 opposite of end 110. Feed cap 254 has feed inlet 268 positioned between ends 108 and 110. Feed cap 254 has cap top 264 and cap side 266. Cap side 266 includes side portion 276 opposite side portion 278.

Ventilation window system 274 has window 274A on side portion 276 proximate end 108 and has window 274B on side portion 278 proximate end 110. Window 274A and end 108 are positioned on feed cap 254 distal from feed inlet 268. Window 274B and end 110 are also positioned on feed cap 254 distal from feed inlet 268. Thus, ventilation window system 274, including windows 274A and 274B, is positioned with respect to feed inlet 268 so as to induce air flow out of ventilation window system 274 and to distribute and induce adhesive pellets 96 (shown in FIG. 3) to settle substantially evenly in melter 248.

In the illustrated embodiment, feed cap 254 is substantially crescent shaped. In alternative embodiments, feed cap 254 can have an elongated shape with end 108 opposite of end 110 other than a crescent shape. In still other embodiments, feed cap 254 can have yet another shape suitable for the application.

FIG. 4B is a perspective view of melter 248, showing melter top 282. Melter 248 includes receptacle 112 for receiving heater cartridge 102 (shown in FIG. 3). Melter 248 also includes collection surface 294 that defines an elongated melter collection area 290. Melter collection area 290 is substantially crescent shaped, complementing the crescent shape of feed cap 254 (shown in FIG. 4A). In alternative embodiments, melter collection area 290 can have an elongated shape other than a crescent shape. In still other embodiments, melter collection area 290 can have yet another shape suitable for the application. Melter 248 has a plurality of passages 298 extending from collection surface 294 near melter top 282 to melter bottom 284 for receiving and melting the adhesive pellets 96 (shown in FIG. 3). Feed cap 294 and ventilation window system 274 (shown in FIG. 4A) can distribute adhesive pellets 96 substantially evenly in melter 248.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. For example, various components of system 10 and melt system 30 can be sized, shaped, and configured differently than as illustrated as appropriate for a given application.

1. A hot melt dispensing system comprising:
a melter for heating adhesive pellets into liquefied adhesive pellets; and
a feed cap connected to the melter, wherein the feed cap comprises:
a cap top and a cap side;
a feed inlet on the cap top for receiving a supply of adhesive pellets and air; and
a first ventilation window on the cap side.

2. The hot melt dispensing system of claim 1, and further comprising:
a container for storing adhesive pellets;
a feed system for transporting adhesive pellets from the container to the feed inlet; and
a dispenser for administering liquefied adhesive pellets from the melter.

3. The hot melt dispensing system of claim 1, wherein the cap side has a first side portion substantially opposite a second side portion, wherein the first ventilation window is positioned on the first side portion, and wherein the feed inlet is positioned on the cap top nearer the second side portion than the first side portion.

4. The hot melt dispensing system of claim 3, and wherein the feed cap further comprises:
a second ventilation window on the second side portion.

5. The hot melt dispensing system of claim 3, and further comprising:
a level sensor positioned on the cap top nearer the first side portion than the second side portion.

6. The hot melt dispensing system of claim 5, wherein the level sensor is connected to the feed cap such that the level sensor is aimed toward a top of the melter.

7. The hot melt dispensing system of claim 3, wherein the feed cap has an elongated shape with a first end and a second end, wherein the first ventilation window is proximate the first end, and wherein the feed cap further comprises:
a second ventilation window on the cap side proximate the second end.

8. The hot melt dispensing system of claim 1, wherein the feed cap connects to a top of the melter so as to define a pellet collection area between the feed cap and the melter.

9. The hot melt dispensing system of claim 1, wherein the cap side is substantially cylindrical, and wherein the feed cap further comprises:
a second ventilation window on the cap side;
a third ventilation window on the cap side; and
a fourth ventilation window on the cap side, wherein the first, second, third, and fourth ventilation windows are spaced substantially symmetrically around the feed cap.

10. A hot melt dispensing system comprising:
a melter for heating adhesive pellets into liquefied adhesive pellets, wherein the melter includes a collection surface defining a melter collection area; and
a feed cap connected to the melter, wherein the feed cap comprises:
a feed inlet for receiving a supply of adhesive pellets and air; and
a ventilation window system positioned with respect to the feed inlet so as to induce air flow out the ventilation window system and to induce the distribution of the adhesive pellets throughout the melter collection area.

11. The hot melt dispensing system of claim 9, wherein the ventilation window system comprises:
at least one window extending through the feed cap at a portion of the feed cap that is distal from the feed inlet.

12. The hot melt dispensing system of claim 10, wherein the ventilation window system comprises:
a plurality of windows extending through the feed cap and positioned substantially symmetrically about the feed cap.

13. The hot melt dispensing system of claim 10, wherein the feed cap has an elongated shape with a first end and a second end, and wherein the ventilation window system comprises:
a first window proximate the first end; and
a second window proximate the second end.

14. The hot melt dispensing system of claim 10, wherein the ventilation window system is positioned with respect to the feed inlet so as to induce flow of the adhesive pellets away from the feed inlet.

15. The hot melt dispensing system of claim 10, wherein the melter comprises a plurality of passages for receiving and melting adhesive pellets.

16. A method of operating a hot melt dispensing system, the method comprising:
transporting adhesive pellets from a container through a feed system;
flowing air and the adhesive pellets from the feed system through a feed inlet of a feed cap attached to a melter; and
flowing air from the feed inlet through the feed cap and out a ventilation window system so as to distribute the adhesive pellets substantially evenly in the melter.

17. The method of claim 16, and further comprising:
melting the adhesive pellets via the melter;
flowing liquefied adhesive pellets to a dispenser; and
administering liquefied adhesive pellets onto an object via the dispenser.

18. The method of claim 16, and further comprising:
flowing the adhesive pellets through a plurality of passages extending from a top of the melter to a bottom of the melter; and
melting the adhesive pellets as the adhesive pellets flow through the plurality of passages.

19. The method of claim 16, wherein the ventilation window system comprises at least one window extending through the feed cap at a portion of the feed cap that is distal from the feed inlet.

20. The method of claim 16, and further comprising:
sensing a level of adhesive pellets in the melter via a level sensor aimed toward a top of the melter.
